(19) United States
(12) Patent Application Publication
(10) Pub. No.: US 2015/0071701 A1
(43) Pub. Date: Mar. 12, 2015

(54) Insert and Method of Attaching Insert to Structure

(71) Applicants: Amool Raina, Austin, TX (US); Teeyana S. Wullenschneider, Balwin City, KS (US); Ryan Michael Barnhart, Lenexa, KS (US); Kyle K. Wetzel, Lawrence, KS (US); Chris Yang, Lawrence, KS (US)

(72) Inventors: Amool Raina, Austin, TX (US); Teeyana S. Wullenschneider, Balwin City, KS (US); Ryan Michael Barnhart, Lenexa, KS (US); Kyle K. Wetzel, Lawrence, KS (US); Chris Yang, Lawrence, KS (US)

(21) Appl. No.: 14/020,563

(22) Filed: Sep. 6, 2013

(51) Int. Cl. F16B 11/00

(52) U.S. Cl. CPC F16B 11/006
USPC 403/266; 403/270; 156/285

(57) ABSTRACT

Example embodiments relate to an insert and a method for attaching the insert to a structure. In example embodiments the structure may be comprised of a composite material, a metal, and a ceramic.

### BACKGROUND

1. Field

Example embodiments relate to an insert and a method of attaching the insert to a structure.

2. Description of the Related Art

In the wind turbine industry, T-bolts are often used to attach a wind turbine blade to a hub. FIGS. 1A and 1B are views of a conventional T-bolt 10. As shown in FIGS. 1A and 1B, the conventional T-bolt 10 includes a threaded stud 2 having threads 4 at a first end thereof and a cross-nut 5 having a threaded hole 7. In the prior art, the hole 7 may be sized to receive the threaded end of the stud 2 so that the threads 4 of the stud 2 engage the threads of the hole 7. The threads of the stud 2 and the cross-nut 5 may be engaged with one another simply by rotating the stud 2 with respect to the cross-nut 5 as is well known in the art.

FIG. 1C is a partial cross-section view of a wind turbine blade 50 illustrating a T-bolt arranged in a root 20 thereof. In the prior art, the T-bolt may be installed by drilling a first hole through material of the root 20 from an outside surface SO of the root 20 through to an inside SI of the root 20. Alternatively, a first hole may be drilled from an inside surface SI to an outside surface SO. The first hole may or may not be drilled completely through the thickness of the root 20. A second hole may then be drilled in a face F of the wind turbine blade root 20 to expose the first hole. The cross-nut 5 may then be inserted into the first hole. The stud 2 may then be inserted into the second hole and pushed through the second hole until the threads 4 of the stud 2 bear up against the threads of the hole 7. The stud 2 may then be rotated to advance the threads 4 of the stud 2 into the hole 7 of the cross-nut 5 thus securing the stud 2 to the cross-nut 5. In FIG. 1C, the stud 2 has a second threaded end with second threads 4′ that enable the stud 2 to attach to a nut 95 thus allowing a secondary structure 90, for example, a hub or a bearing of a wind turbine, to be connected to the wind turbine blade 50 as shown in FIG. 1D.

As an alternative to T-bolts, some artisans have used inserts as a means for attaching a wind turbine blade to a wind turbine hub. For example, in WO 20111035548A1 a plurality of inserts is attached to a root of a wind turbine blade during a lamination process and a plurality of studs is used to connect the wind turbine blade to a hub using the plurality of inserts. Other artisans have turned to metal inserts as part of an assembly system. The metal inserts are often bonded into fiber-reinforced plastic composite structures, for example, a root of a wind turbine blade. A common method of fabrication is to drill a hole in the composite structure, position the insert in the hole using a fixture, and inject the adhesive into the hole around the insert through either a secondary hole drilled into the first hole or through the gap in the face of the structure. Another method of fabrication is to drill a hole in the composite structure, apply the adhesive to the outer surface of the metal insert and/or the inside of the hole, and position the insert in the hole using a fixture. In the aforementioned methods an artisan may assist the application and/or cure of the adhesive by sealing the open end of the first hole in the structure.

### SUMMARY

The inventor has noticed several problems associated with conventional methods for attaching a wind turbine blade to a wind turbine hub. Such problems are also suffered in other industries and, as such, are not limited to the wind turbine industry. For example, when T-bolts are used, relatively large compressive stresses may be present in the root near the cross-nuts of the T-bolts. These stresses may lead to failure, for example by cleaving of fibers near the cross-nuts. To alleviate this problem, a larger diameter cross-nut may be used, but this increases the perforations of the root which may result in increased warping in the cross-nut holes and/or root cylinder when the structure is subjected to loads. With regard to laminating inserts in place, this process results in a root having voids created near the inserts which act as stress concentrators leading to delamination near the inserts. With regard to bonding metal inserts, it is extremely challenging to ensure thorough fill of the space around the insert without macroscopic voids created by trapped air. Macroscopic voids are to be distinguished from microscopic voids due to air entrained into the adhesive due to the mixing process, the latter being accounted in the nominal properties of the adhesive. Macroscopic voids create stress concentrations when the structure and insert are subjected to loads. The method has a second short-coming in that it can be challenging to fixture the insert concentrically in the hole to ensure a uniform bond thickness. Nonuniform bond thickness can also create stress concentrations. Stress concentrations can cause premature failure of the part.

With the above in mind, the inventor has set out to design a method which may be used to embed an insert, for example, a female-threaded insert, into a structure, for example, a composite structure, that does not suffer the aforementioned problems. As a result, the inventor has developed a novel and nonobvious insert, system, and method for bonding an insert, for example, a female-threaded metal insert, into a composite structure. Such a method is useful in various industries. For example, the novel method may be used to connect a wind turbine blade to a hub of a wind turbine. Application to the wind turbine industry and wind turbine structures is not intended to be a limiting feature of the invention since the invention may be applied to a variety of industries and/or structures. For example, other applications include, but are not limited to, the aerospace, automobile, construction, and/or boating industries or any industry where it is desired to bond an insert into a structure.

Example embodiments of the invention include an insert. In example embodiments the insert may be placed in a cavity formed in a structure, for example, a composite structure. In example embodiments, various sealing members may be provided to make the hole an airtight chamber. In example embodiments, a vacuum may be applied to the hole to remove air therefrom. Under vacuum, an adhesive may be applied inside the cavity to bond the insert therein. Because the adhesive is applied under a vacuum, macroscopic voids in the adhesive may be eliminated thereby leading to a bond having a relatively long service life in comparison to the conventional art.

### BRIEF DESCRIPTION OF THE DRAWINGS

Example embodiments are described in detail below with reference to the attached drawing figures, wherein:

FIG. 1A is a view of a T-bolt in accordance with the prior art;

FIG. 1B is an exploded view of the T-bolt in accordance with the prior art;

FIG. 1C is a partial cross-section of a wind turbine blade root with a T-bolt therein in accordance with the prior art;

FIG. 1D is a partial cross-section of a wind turbine blade root attached to a second structure in accordance with the prior art;

FIG. 2A is a front view of an assembly accordance with example embodiments;

FIG. 2B is a side view of the assembly in accordance with example embodiments;

FIG. 2C is a cross-section view of the assembly in accordance with example embodiments;

FIG. 2D is a cross-section view of an assembly in accordance with example embodiments

FIG. 3A is a front view of an insert in accordance with example embodiments;

FIG. 3B is a side view of the insert in accordance with example embodiments;

FIG. 3C is a cross-section view of the insert in accordance with example embodiments;

FIG. 3D is a cross-section view of an insert in accordance with example embodiments;

FIG. 4A is a front view of a sealing member in accordance with example embodiments;

FIG. 4B is a side view of the sealing member in accordance with example embodiments;

FIG. 5A is a side view of an applicator unit in accordance with example embodiments;

FIG. 5B is a perspective view of an applicator unit in accordance with example embodiments;

FIGS. 6A-6C illustrate example assembly steps for forming the assembly in accordance with example embodiments;

FIGS. 6D and 6E illustrate examples of assemblies in accordance with example embodiments;

FIG. 7A illustrates a partial section view of a structure in accordance with example embodiments;

FIG. 7B illustrates the structure having a cavity in accordance with example embodiments; and

FIGS. 8A-8B illustrate an assembly being inserted into the cavity in the structure in accordance with example embodiments;

FIG. 8C illustrates a vacuum system and an adhesive supply unit attached to the assembly inserted into the cavity of the structure in accordance with example embodiments;

FIGS. 8D-8I illustrate an adhesive filling a space between the insert and the structure to bond the insert to the structure in accordance with example embodiments;

FIG. 8J illustrates tubes of the assembly in a cut configuration in accordance with example embodiments;

FIGS. 9A and 9B illustrate a stud being attached to an insert bonded to a structure in accordance with example embodiments;

FIGS. 10A-10D illustrate operations of bolting a second structure to a first structure using the inserts and studs according to example embodiments;

FIG. 11 illustrates a root of a wind turbine blade with a plurality of inserts in accordance with example embodiments;

FIGS. 12A-12C illustrate an assembly in accordance with example embodiments;

FIGS. 13A-13C illustrate an assembly in accordance with example embodiments;

FIGS. 14A-14C illustrate assemblies with spacers in accordance with example embodiments;

FIGS. 15A-15B illustrate an assembly in accordance with example embodiments;

FIGS. 16A-16D are views of an assembly in accordance with example embodiments; and

FIGS. 17A-17D illustrate an operation of inserting and bonding an insert to a structure.

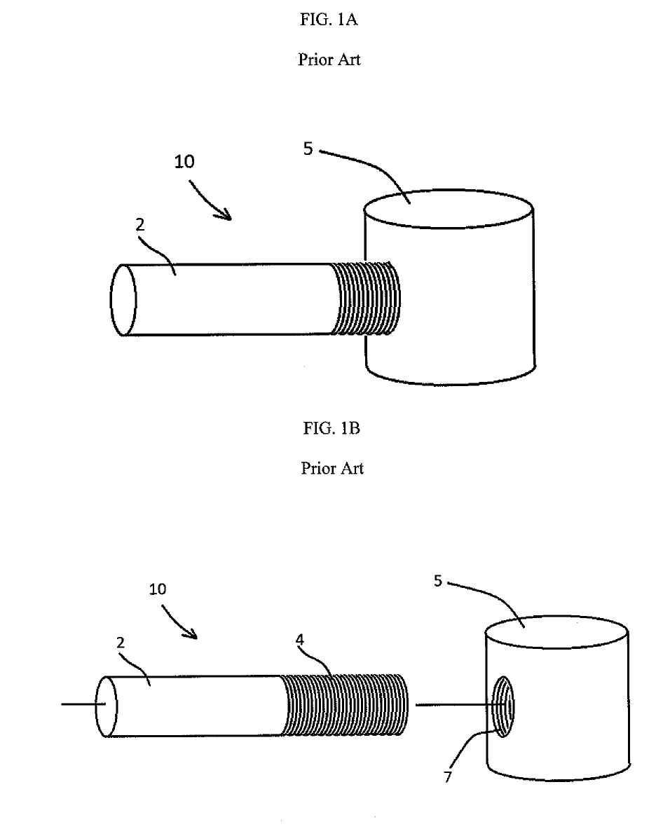

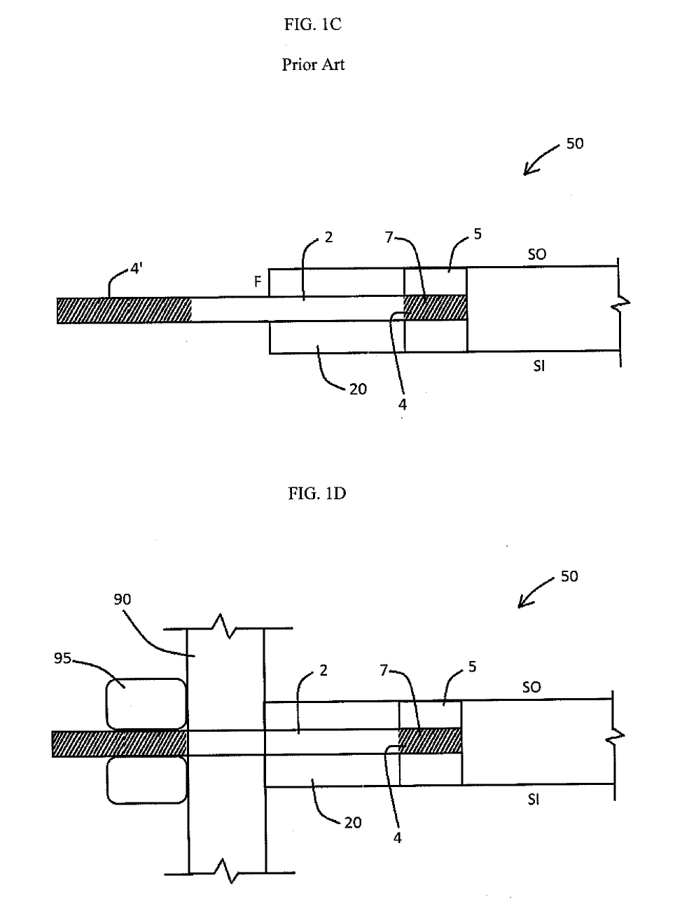

### DETAILED DESCRIPTION

Example embodiments will now be described more fully with reference to the accompanying drawings, in which example embodiments of the invention are shown. The invention may, however, be embodied in different forms and should not be construed as limited to the example embodiments set forth herein. Rather, these example embodiments are provided so that this disclosure will be thorough and complete, and will fully convey the scope of the invention to those skilled in the art. In the drawings, the sizes of components may be exaggerated for clarity.

In this application, it is understood that when an element or layer is referred to as being “on,” “attached to,” “connected to,” or “coupled to” another element or layer, it can be directly on, directly attached to, directly connected to, or directly coupled to the other element or layer or intervening elements that may be present. In contrast, when an element is referred to as being “directly on,” “directly attached to,” “directly connected to,” or “directly coupled to” another element, there are no intervening elements present. As used herein, the term “and/or” includes any and all combinations of one or more of the associated listed items.

In this application it is understood that, although the terms first, second, etc. may be used herein to describe various elements and/or components, these elements and/or components should not be limited by these terms. These terms are only used to distinguish one element, component, region, layer, and/or section from another element, component, region, layer, and/or section. Thus, a first element, component region, layer or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the structure in use or operation in addition to the orientation depicted in the figures. For example, if the structure in the figures is turned over, elements described as “below” or “beneath” other elements or features would then be oriented “above” the other elements or features. Thus, the exemplary term “below” can encompass both an orientation of above and below. The structure may be otherwise oriented (rotated 90 degrees or at other orientations) and the spatially relative descriptors used herein interpreted accordingly.

Embodiments described herein will refer to planform views and/or cross-sectional views by way of ideal schematic views. Accordingly, the views may be modified depending on manufacturing technologies and/or tolerances. Therefore, example embodiments are not limited to those shown in the views, but include modifications in configurations formed on the basis of manufacturing process. Therefore, regions exemplified in the figures have schematic properties and shapes of regions shown in the figures, and do not limit example embodiments.

The subject matter of example embodiments, as disclosed herein, is described with specificity to meet statutory requirements. However, the description itself is not intended to limit the scope of this patent. Rather, the inventors have contemplated that the claimed subject matter might also be embodied in other ways, to include different features or combinations of features similar to the ones described in this document, in conjunction with other technologies. Generally, example embodiments relate to an insert and a method for attaching the insert to a structure.

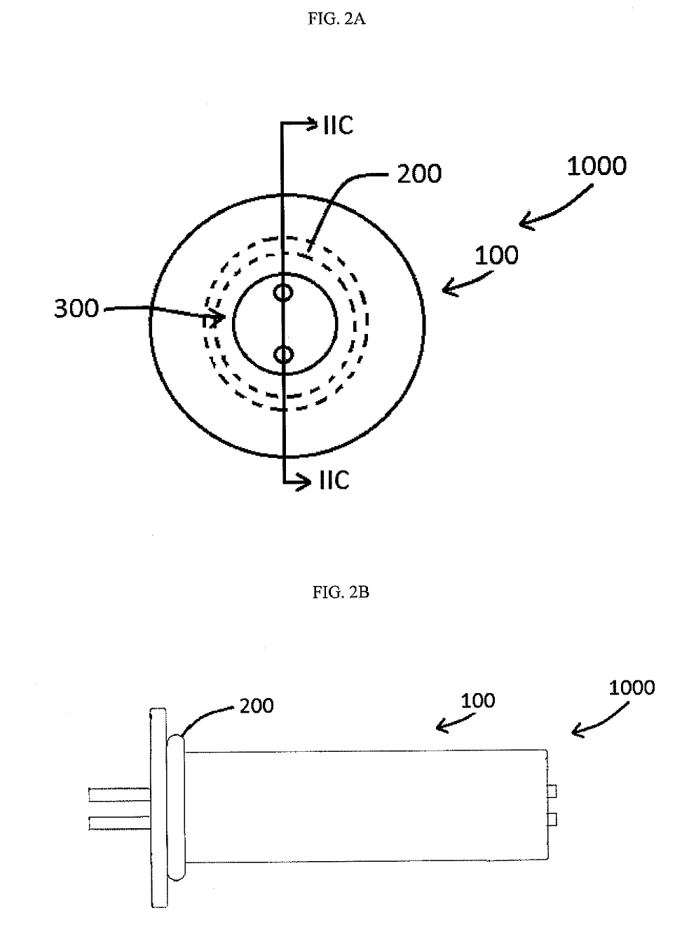

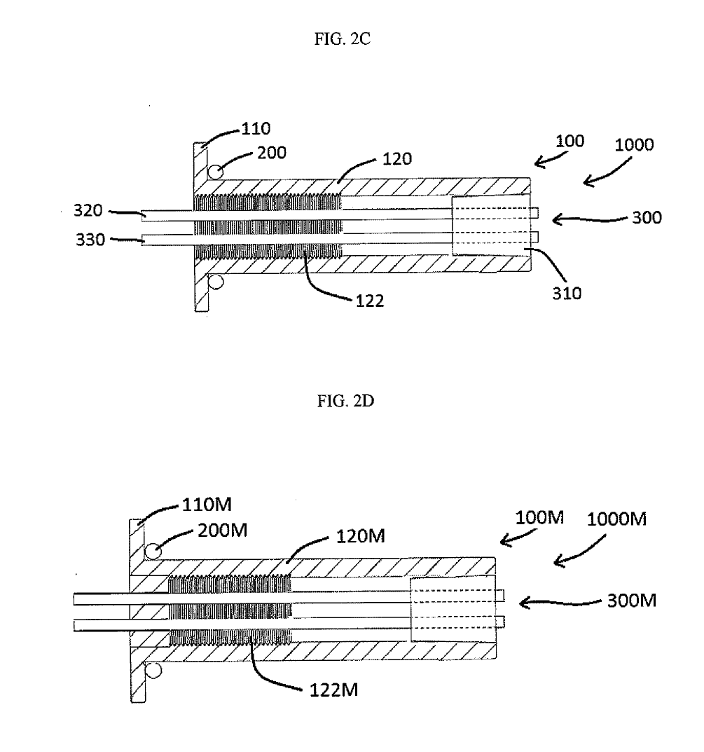

FIG. 2A is a front view of an assembly 1000 in accordance with example embodiments, FIG. 2B is a side view of the assembly 1000 in accordance with example embodiments, and FIG. 2C is a cross-section view of the assembly 1000 in accordance with example embodiments. Referring to FIGS. 2A-2C, the assembly 1000 may be comprised of an insert 100, a sealing member 200, and an applicator unit 300. As shown in FIGS. 2A-2C, the sealing member 200 may be arranged on an outside of the insert 100 and the applicator unit 300 may be enclosed, at least partially, by the insert 100.

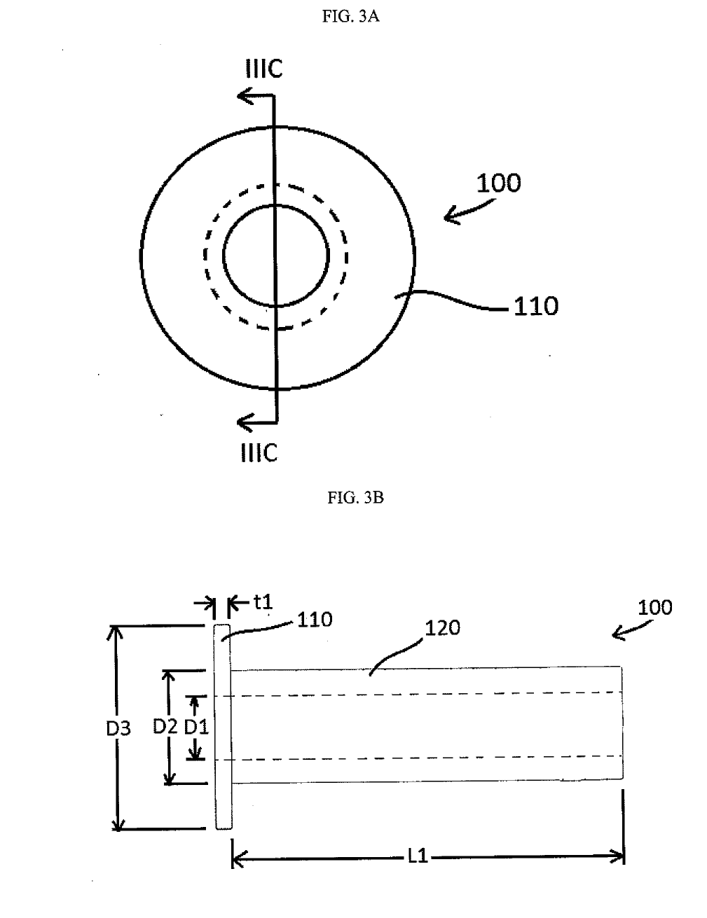

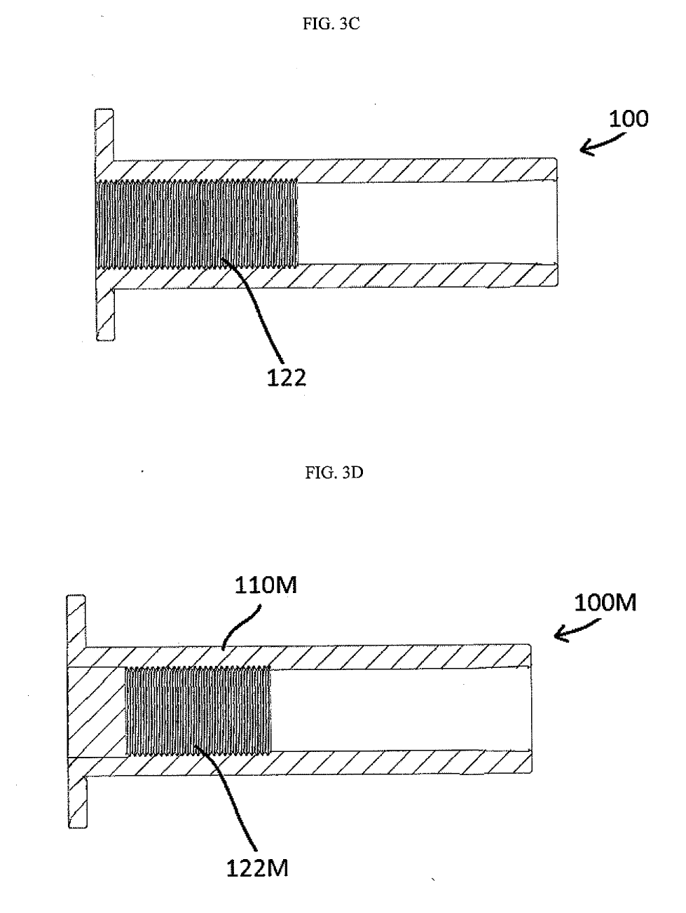

FIG. 3A is a front view of the insert 100 in accordance with example embodiments, FIG. 3B is a side view of the insert 100 in accordance with example embodiments, and FIG. 3C is a cross-section view of the insert 100 in accordance with example embodiments. Referring to FIGS. 3A-3C, the insert 100 may include a cylindrical body 120 with a flange 110 at one end thereof. In example embodiments, the flange 110 may resemble an annular disk having an inner diameter of D1, an outer diameter of D3, and a thickness t1. Although the flange 110 is illustrated as resembling an annular disk, example embodiments are not limited thereto as the flange 110 may resemble another shape such as, but not limited to, a square or rectangular plate having a circular hole having the diameter D1.

In example embodiments, the cylindrical body 120 may resemble a substantially hollow cylinder having a length L1, an inner diameter D1, and an outer diameter D2. In example embodiments, an internal surface of the cylindrical body 120 may be threaded as shown in FIG. 3C. In example embodiments, the threads 122 of the cylindrical body 120 may be configured to engage threads of a stud (as will be explained later). In example embodiments, the outer diameter D2 of the cylindrical body 120 may be smaller than the outer diameter D3 of the flange 110 and the flange 110 may thus serve as a structure upon which the sealing member 200 may bear. In example embodiments, the threads 122 may extend along a discrete length of the internal surface of the body 120 (as shown in FIG. 3C) or along the entire length of the body 120. Thus, the position and length of the threads 122 illustrated in the figures is not intended to limit the invention.

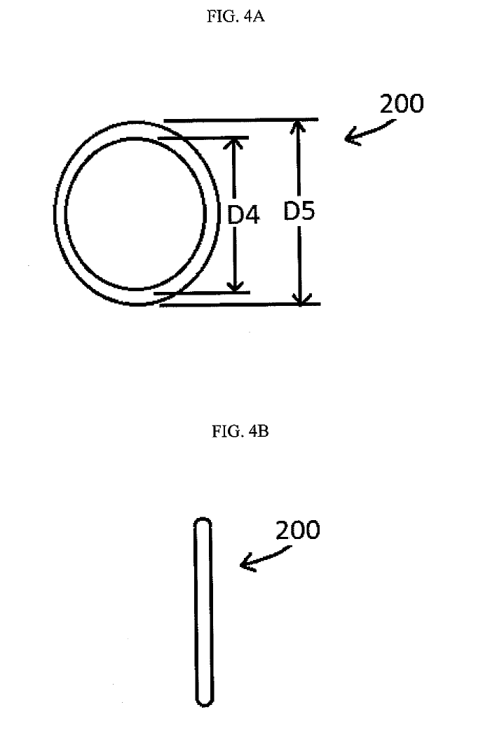

FIGS. 4A and 4B are views of the sealing member 200 in accordance with example embodiments. In example embodiments, the sealing member 200 may resemble an o-ring having an inner diameter of D4 and an outer diameter of D5. In example embodiments, the inner diameter D4 may be about the same size as the outer diameter D2 of the cylindrical body 120. In example embodiments, the sealing member 200 may be made of a flexible material, for example, rubber or plastic, and thus may be stretched. In the event the sealing member 200 is made of a flexible material, the sealing member 200 may stretch somewhat. Thus, in example embodiments, the inner diameter D4 of the sealing member 200, in an unstressed state, may be smaller than the outer diameter D2 of the cylindrical body 120. Example embodiments, however, are not limited thereto as the inner diameter D4 of the sealing member 200 may be about the same size as, or larger than, the outer diameter D2 of the cylindrical body 120. In some views the sealing member 200 is illustrated as having a circular cross section. This, however, is not meant to be a limiting feature since a cross section of the sealing member 200 may have a different shape such as, but not limited to, a square or rectangular shape.

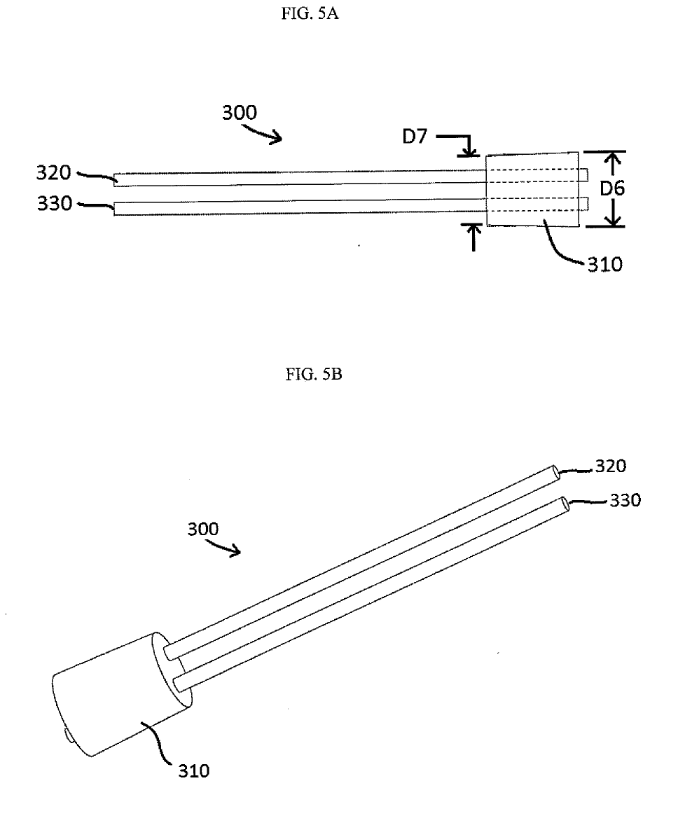

FIGS. 5A and 5B are views of the applicator unit 300 in accordance with example embodiments. In example embodiments, the applicator unit 300 may include a body 310 and first and second tubes 320 and 330 that penetrate the body 310. In example embodiments the body 310 may be made of a flexible material such as, but not limited to, rubber or a cork type material. In example embodiments, the body 310 may resemble a partial cone having a first diameter D6 and a second diameter D7 which may be about the same size as, or smaller than the first diameter D6. In example embodiments, the second diameter D7 may be smaller than the inner diameter D1 of the cylindrical body 120 and the first diameter D6 may be larger than the inner diameter D1 of the cylindrical body 120. As a consequence, the body 310 may be partially inserted into the cylindrical body 120 with application of little to no force. In example embodiments, because the body 310 may be made of a flexible material, the body 310 may be pushed into the cylindrical body 120 thereby reducing the first diameter D6 to that of the inner diameter D1 of the cylindrical body 120. In doing so, the body 310 may create a seal in the cylindrical body 120. In this particular nonlimiting example, the seal is created at an end of the cylindrical body 120.

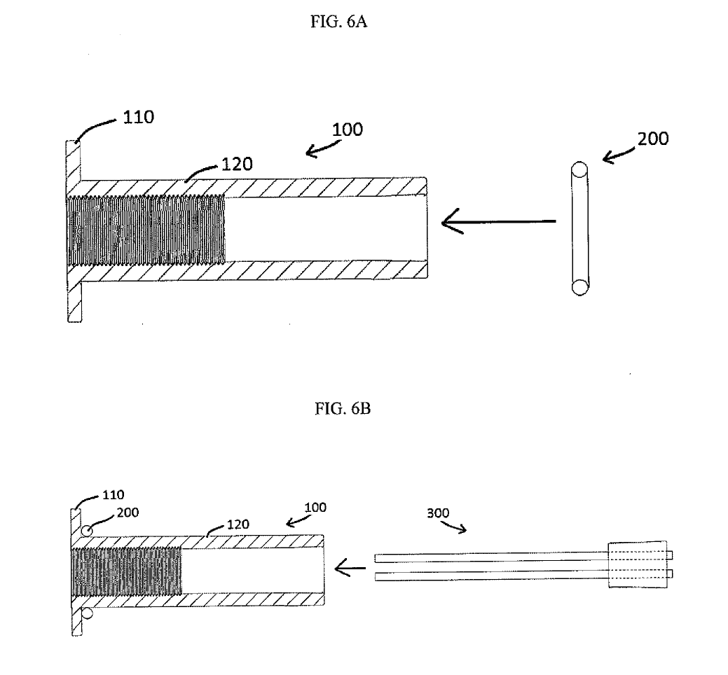

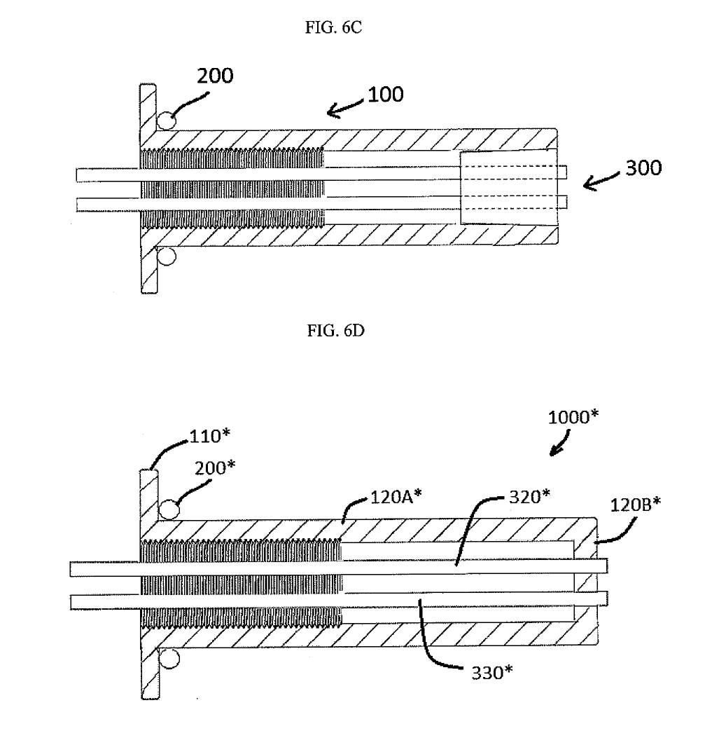

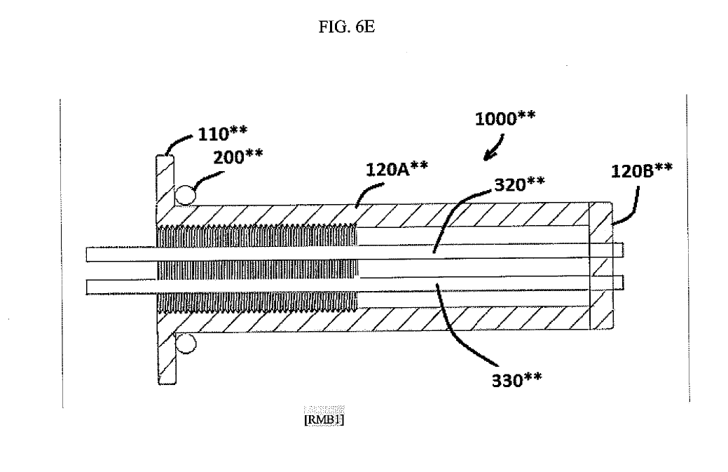

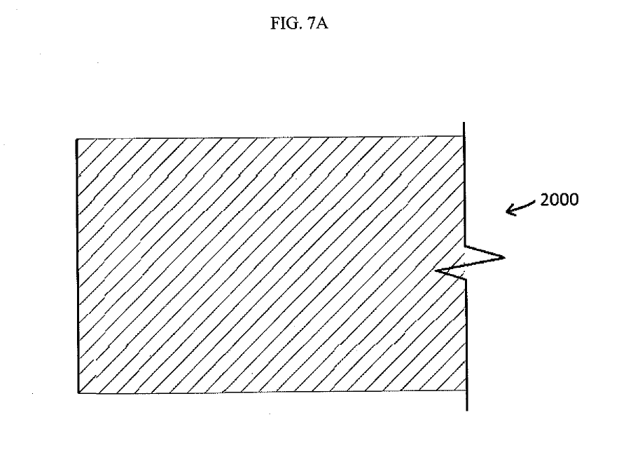

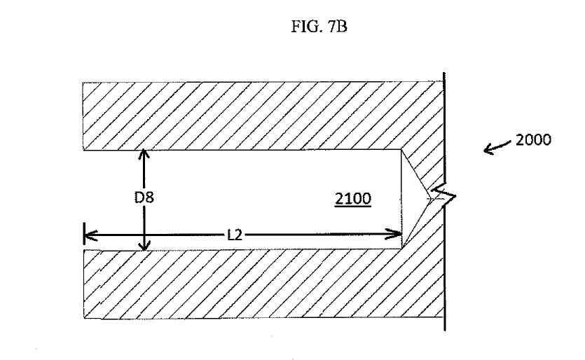

FIGS. 6A-6C illustrate operations of assembling the assembly 1000. As shown in FIG. 6A, the sealing member 200 may moved along the cylindrical body 120 until it reaches the flange 110 as shown in FIG. 6B. Then, the applicator unit 300 may be pushed into the second end of the cylindrical body 120 as shown in FIG. 6B until the second end of the cylindrical body 120 is sealed as shown in FIG. 6C. In example embodiments, the first and second tubes 310 and 320 may be exposed at a first end of the cylindrical body 120 and at the second end of the cylindrical body 120. The order of assembly is relatively unimportant. For example, in FIGS. 6A-6C it is illustrated that the sealing member 200 is placed on the cylindrical body 120 before the applicator unit 300 is installed. However, in example embodiments, the applicator unit 300 may be installed before the sealing unit 200 is moved along the cylindrical body 120.

The embodiment of FIGS. 2A-2C is not intended to limit the invention. For example, FIG. 2D shows a cross-section of a similar assembly 1000M. In example embodiments, the assembly 1000M may be substantially identical to the assembly 1000. For example, the assembly 1000M may have a sealing member 200M and an applicator unit 300M which may be substantially identical to the earlier described sealing member 200 and applicator unit 300. Furthermore, the assembly 1000M may include an insert 100M which is substantially similar to the insert 100. However, in FIG. 2D, the insert 100M only has threads 122M running along a portion of cylindrical body 120M. All other aspects of the assembly 1000 and 1000M may be identical. A benefit of the assembly 1000M, however, is that it allows for the pretensioning of a stud if such pretensioning is desired. FIG. 3D illustrates a cross-section of the insert 100M clearly showing a lack of threads near an opening of the insert 100M near a face of the flange 110M of the insert 100M.

FIG. 7A illustrates a structure 2000 and FIG. 7B illustrates the structure 2000 with a cavity 2100 formed therein. In example embodiments, the structure 2000 may be, but is not limited to, a root of a wind turbine blade. The structure 2000, however, may be something other than a wind turbine blade. For example, the structure 2000 may be a panel of an automobile or an airplane wing or any other structure that has a cavity formed therein. In example embodiments the structure 2000 may be a composite material, however, the invention is not limited thereto. For example, the structure 2000 may be made from another material such as, but not limited to, a metal or a ceramic. In example embodiments, the cavity 2100 may be formed therein by a conventional method such as, but not limited to, a boring method, a drilling method, a pressing method, a punching method, a printing method, or a casting process. In example embodiments, the cavity 2100 may have a depth L2 and a diameter D8. In example embodiments, the depth L2 should be longer that the length L1 of the cylindrical body 120 (see FIG. 3B) and the diameter D8 should be larger than the outer diameter D2 of the cylindrical body 120 but smaller than the outer diameter D5 of the sealing member 200.

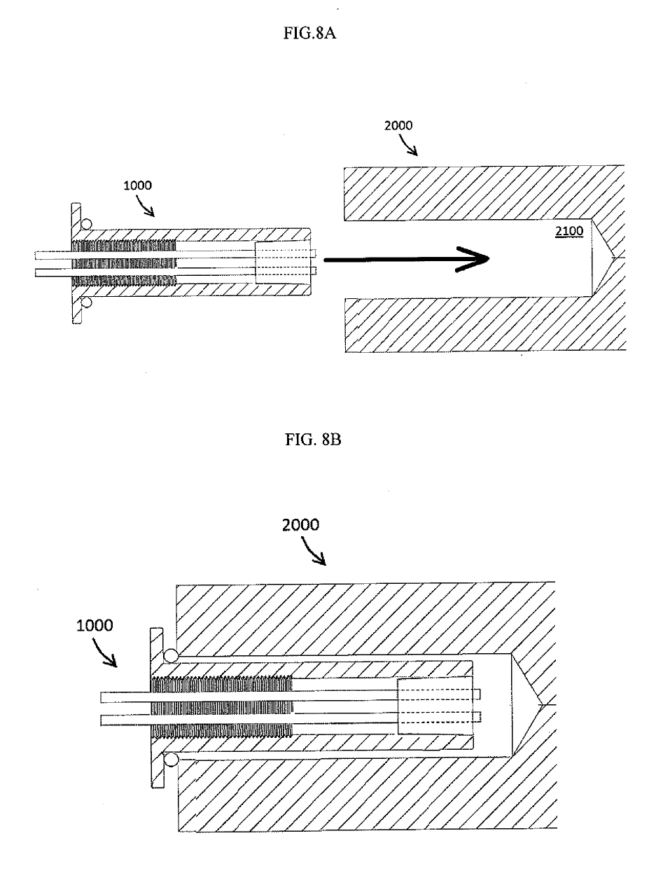

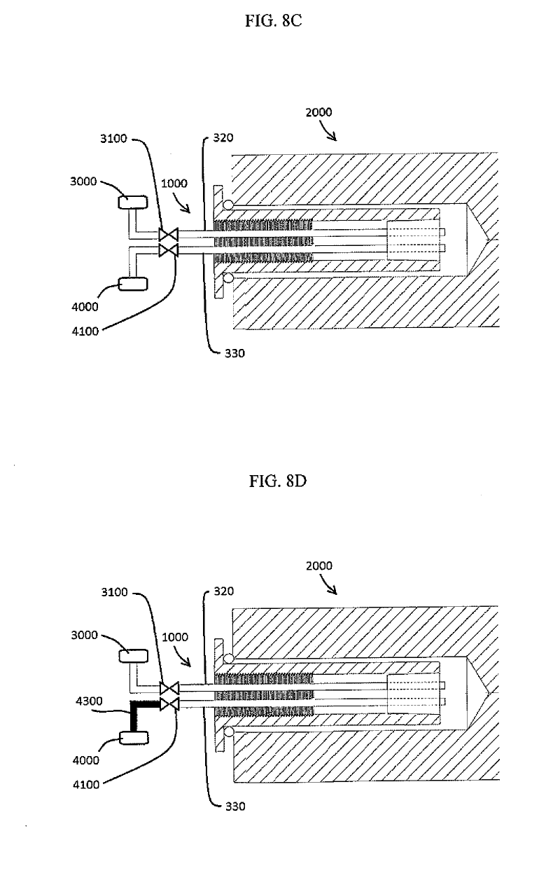

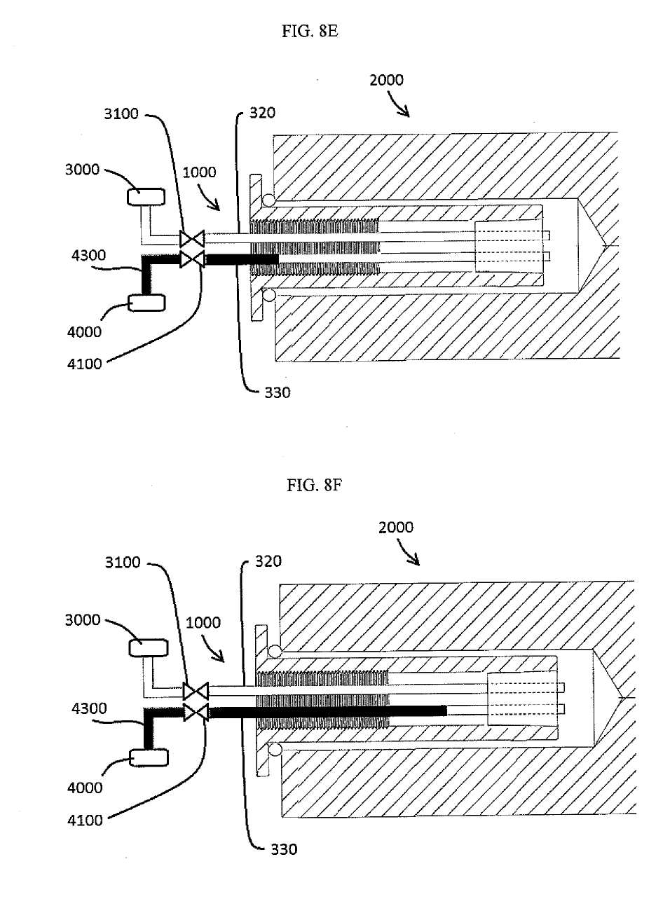

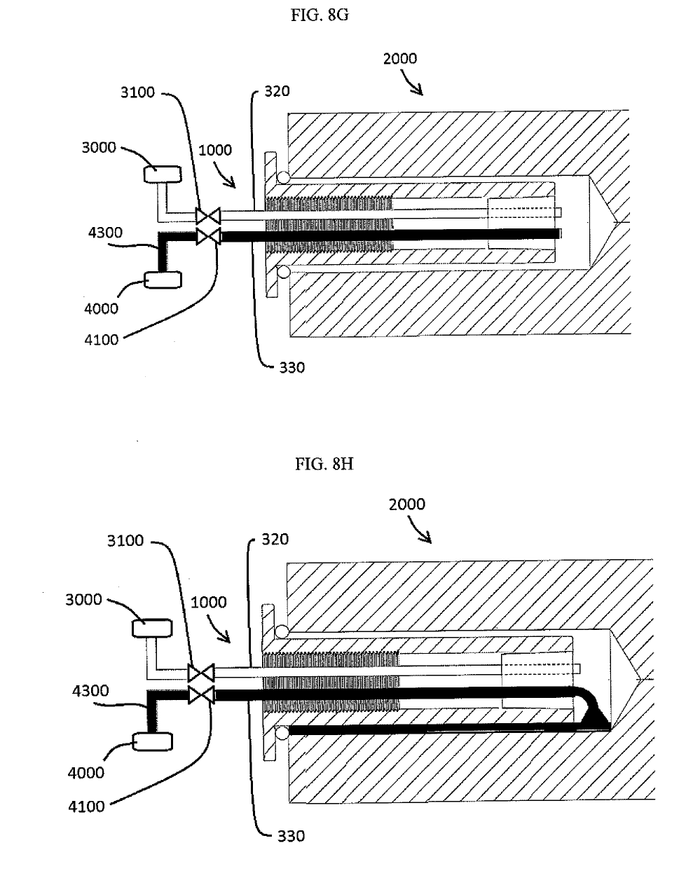

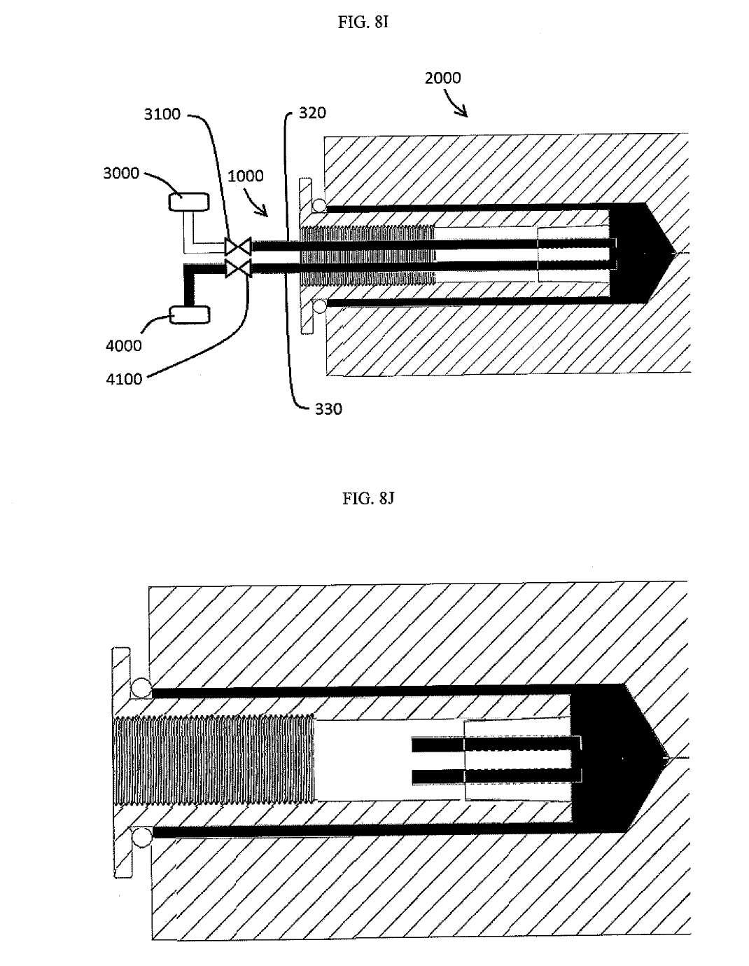

FIGS. 8A and 8B illustrate a portion of the assembly 1000 being inserted into the cavity 2100 formed in the structure 2000. In example embodiments, the cylindrical body 120 of the insert 100 may be inserted into the cavity 2100 until the sealing member 200 contacts the structure 2000 as shown in FIG. 8B.

In example embodiments, the first tube 320 may be attached to a vacuum system 3000 and the second tube 330 may be attached to an adhesive supply unit 4000. In order to attach the insert 100 to the structure 2000, the second tube 330 may be initially clamped or shut off (for example, by closing valve 4100) so that adhesive may not flow through the second tube 330. At this point, a vacuum may be applied to the first tube 320 by activating the vacuum system 3000. This vacuum may draw air out of the cavity 2100 thereby creating a vacuum in the cavity 2100. Due to the presence of the sealing member 200, the cavity 2100 may maintain a vacuum state as shown in FIG. 8C even when the vacuum system 3000 is shut off. After the air from the cavity 2100 is drawn out, a valve 3100 associated with the vacuum system 3000 may be closed and an adhesive from the adhesive supply unit 4000 may be provided to the cavity 2100 through the second tube 330 which may fill the cavity 2100. FIGS. 8E-8I illustrate an adhesive 4300 flowing through the assembly 1000 and into and throughout the cavity 2100 so that the adhesive 4300 may bond the insert 100 to the structure 2000. Because the adhesive 4300 is provided in a vacuum, macroscopic voids in the adhesive 4300 are eliminated, thus producing a bond having superior strength characteristics when compared to the conventional art. After the adhesive 4300 has cured, the first and second tubes 320 and 330 may be cut as shown in FIG. 8J. Although FIGS. 8A-8J illustrate the assembly 1000 being inserted into the cavity 2100, it is understood the assembly 1000M may be used in lieu of the assembly 1000 without departing from the teachings of FIGS. 8A-8J and the above discussion.

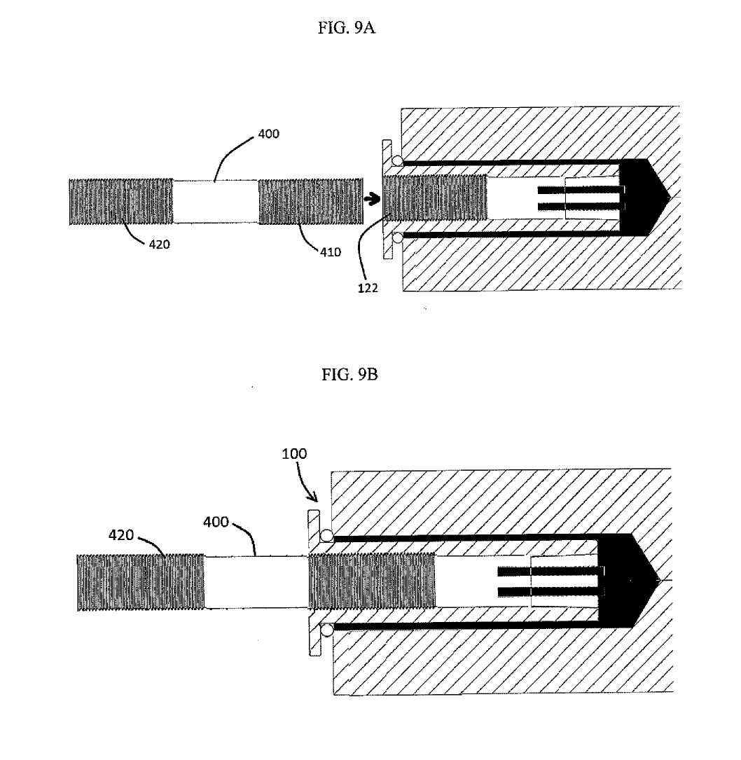

FIGS. 9A and 9B illustrate a stud 400 being arranged near an insert 100 which is bonded to the structure 2000. In example embodiments, the stud 400 may have a first end with first threads 410 and a second end with second threads 420. In example embodiments, the stud 400 may be arranged near the insert 100 as shown in FIG. 9A so that the first threads 410 bear against the threads 122 of the insert 100. Once in contact, the stud 400 may be rotated so that the stud 400 advances along the cylindrical body 120 of the insert 100 due to the threads 410 of the stud 400 being engaged with the threads 122 of the cylindrical body 122. In example embodiments, the stud 400 may be advanced along the insert 100 until the stud 400 is at a desired location, for example, as shown in FIG. 9B.

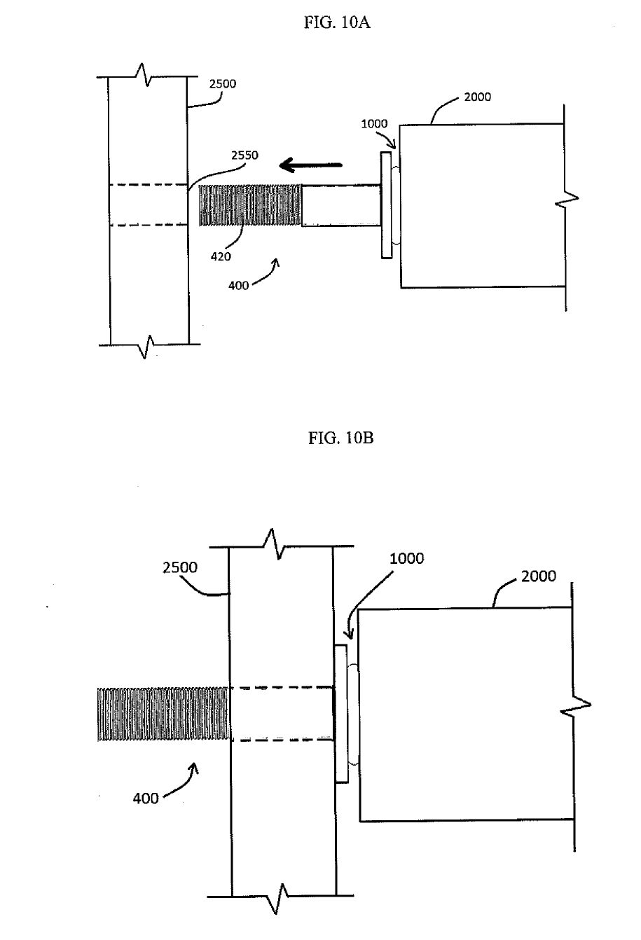

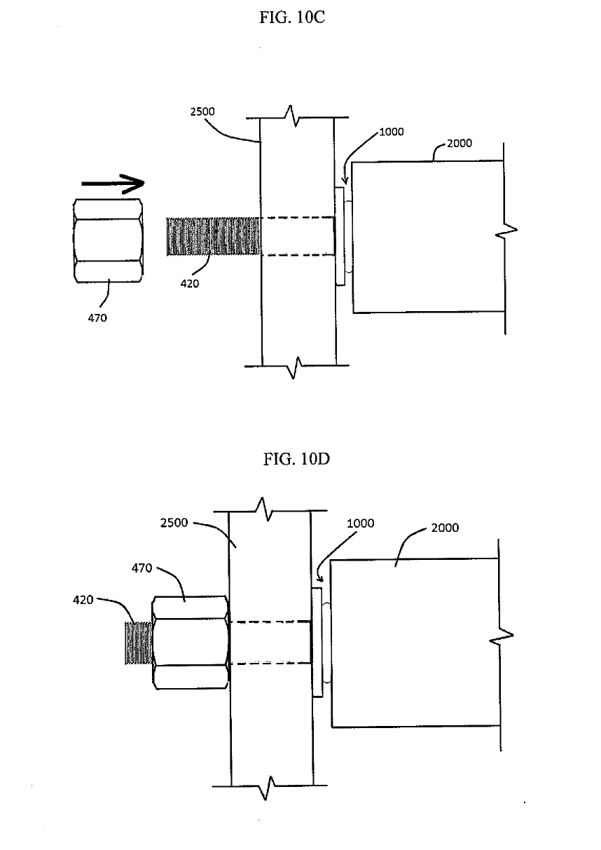

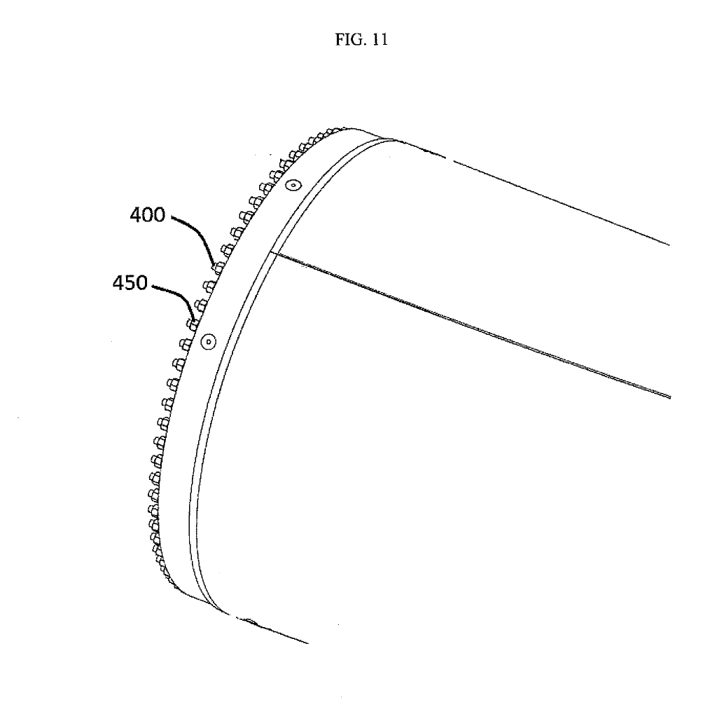

FIG. 10A illustrates the insert 100 embedded in a structure 2000 as described above. FIG. 10A also shows a stud 400 attached to the insert 100 as provided above. In example embodiments, the structure 2000 with the insert 100 embedded therein and the stud 400 may be moved to a second structure 2500 that has a hole 2550 large enough for the stud 400 to pass through. In example embodiments, the structure 2000 with the insert embedded therein and the stud 400 attached thereto may be moved so that the stud 400 passes through the hole 2550 of the second structure 2500 as shown in FIG. 10B. Once in position, a nut 470 may be attached to the stud 400 to secure the second structure 2500 to the first structure 2000 as shown in FIGS. 10C and 10D.

FIG. 11 illustrates a root of a wind turbine blade attached at the root end to a hub through the use of a series of studs 400 and nuts 450 arranged in a circle. The studs 400 extend from the root of the blade in a manner consistent with that described above and are secured with a nut to a bearing on the hub. This particular nonlimiting example illustrates at least one practical application of example embodiments.

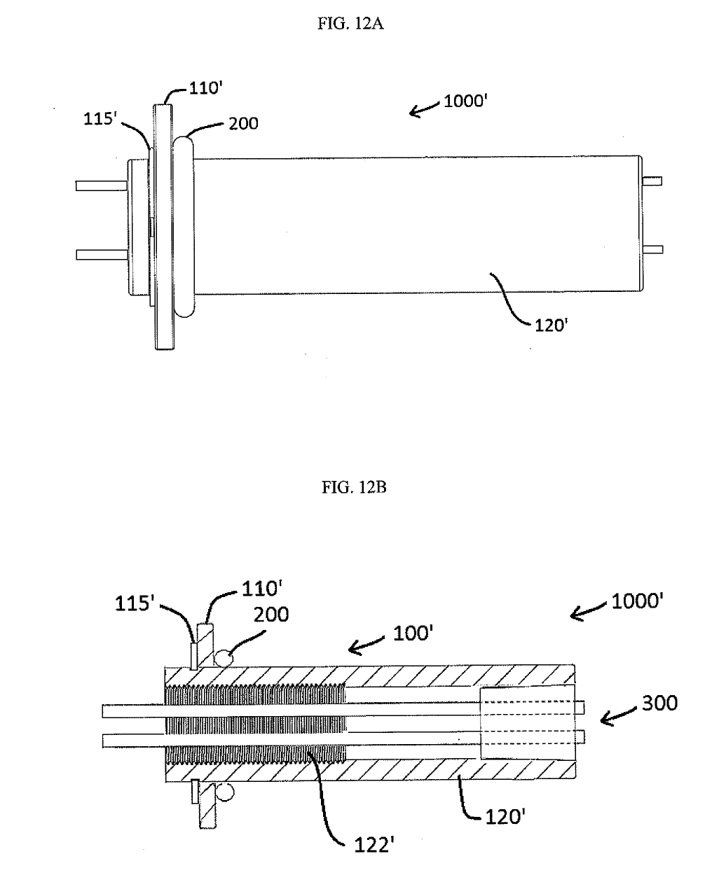

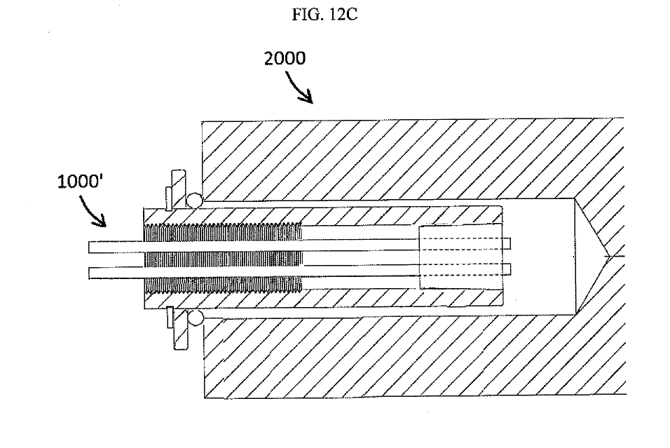

FIG. 12A illustrates another example of an assembly 1000′ in accordance with example embodiments and FIG. 12B is a cross-section of the assembly 1000′ in accordance with example embodiments. As shown in FIGS. 12A and 12B, the assembly 1000′ is substantially similar to the assembly 1000 in that it includes a sealing member 200, and an applicator unit 300 which may be substantially similar to the sealing member 200 and the applicator unit 300 of the assembly 1000. However, in example embodiments, the assembly 1000′ includes an insert 100′ that does not include a flange. Rather, the insert 100′ includes only a cylindrical body 120′ similar to the previously described cylindrical body 120. Also, rather than having a flange, the insert 100′ includes a washer 110′ and a snap ring 115′ at one end of a cylindrical body 120′. In example embodiments, the snap ring 115′ may reside in a groove which may extend around a circumference of the insert 100′. In example embodiments, the assembly 1000′ may be placed in a cavity 2100 of a structure 2000 as shown in FIG. 12C. In this case, the sealing member 200 is sandwiched between the washer 110′ and the structure 2000 rather than between a flange and the structure 2000. In example embodiments, an adhesive may be provided under vacuum to secure the insert 100′ to the structure 2000 in a manner similar to that provided above. Thus, a detailed description thereof is omitted for the sake of brevity. Also, in example embodiments, the cylindrical body 120′ of the insert 100′ may include threads 122′ as shown in FIG. 12B so that a stud may be attached thereto. In example embodiments, the threads 122′ may run along an entire length of the cylindrical body 120′ or portion of the cylindrical body 120′ as shown in FIG. 12C. On the other hand, the threads may not extend to an end of the cylindrical body 120′ and may, instead, resemble the arrangement illustrated in FIGS. 2D and 3D.

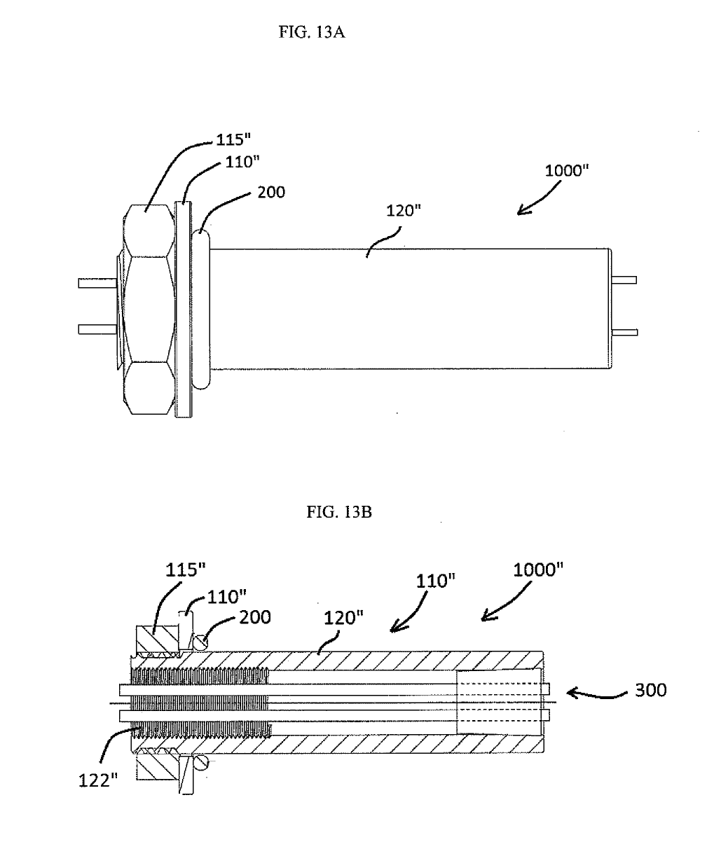

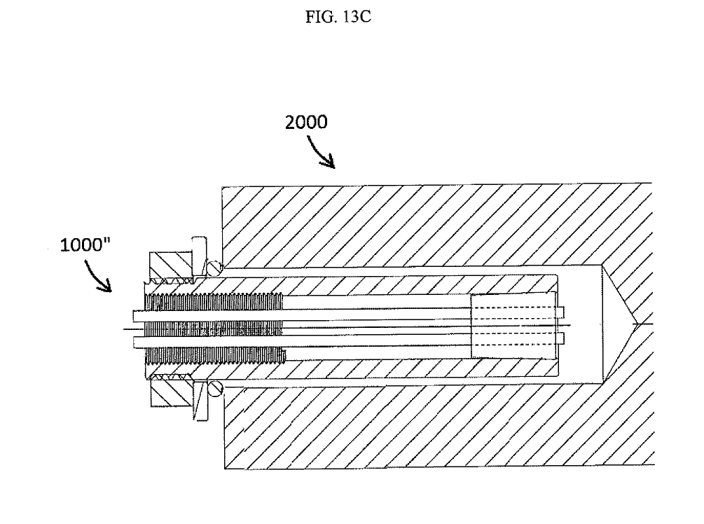

FIG. 13A illustrates another example of an assembly 1000″ in accordance with example embodiments and FIG. 13B is a cross-section of the assembly 1000″ in accordance with example embodiments. As shown in FIGS. 13A and 13B, the assembly 1000″ is substantially similar to the assembly 1000 in that it includes a sealing member 200, and an applicator unit 300 which may be substantially similar to the sealing member 200 and the applicator unit 300 of the assembly 1000. However, in example embodiments, the assembly 1000″ includes an insert 100″ having a cylindrical body 120″ and no flange. Rather than having a flange, the insert 100″ includes a washer 110″ and a nut 115″ which interfaces with a threaded end of the insert 100″. In example embodiments, the assembly 100″ may be placed in a cavity 2100 of a structure 2000 as shown in FIG. 13C. In this case, the sealing member 200 is sandwiched between the washer 110″ and the structure 2000 rather than between a flange and the structure 2000. In example embodiments, an adhesive may be provided under a vacuum to secure the insert 100″ to the structure 2000 in a manner similar to that provided above. Thus, a detailed description thereof is omitted for the sake of brevity. Also, in example embodiments, the cylindrical body 120″ of the insert 100″ may include threads 122″ as shown in FIG. 13B so that a stud may be attached thereto. In example embodiments, the threads 122″ may run along an entire length of the cylindrical body 120″ or portion of the cylindrical body 120″ as shown in FIG. 13B. On the other hand, the threads 122″ may not extend to an end of the cylindrical body and may, instead, resemble the arrangement illustrated in FIGS. 2D and 3D.

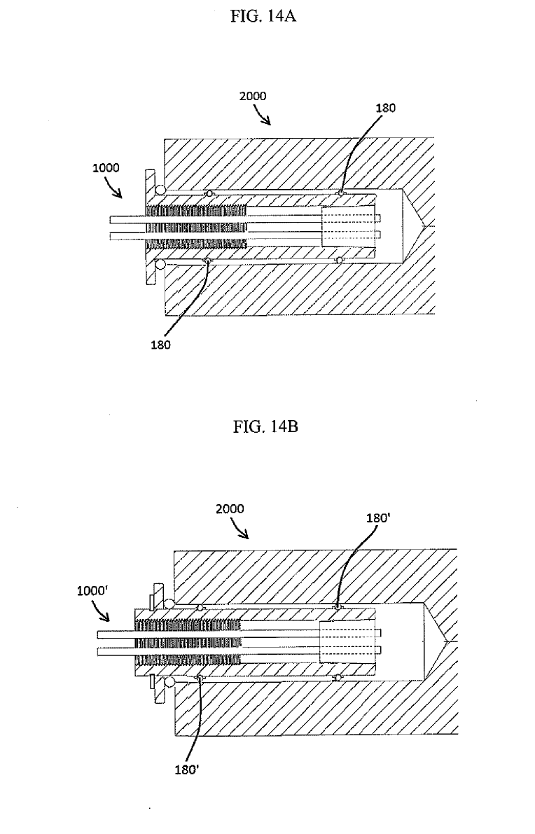

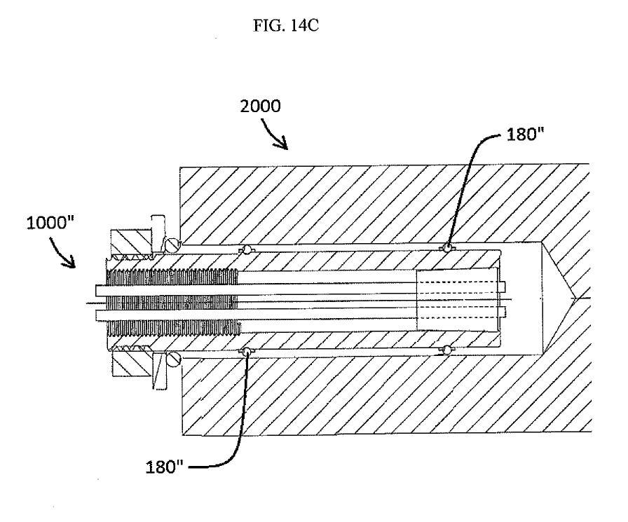

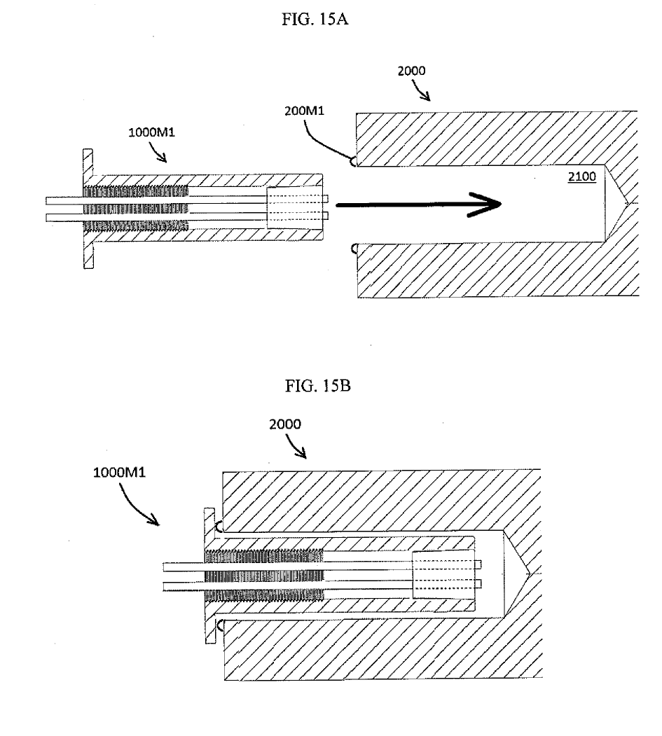

FIGS. 14A-14C illustrate the assemblies 1000, 1000′, and 1000″ with a slight modification thereto. In FIGS. 14A-14C the assemblies 1000, 1000′, and 1000″ are fitted with spacers 180, 180′, and 180″ to maintain separation between walls of the structure 2000 forming the cavity 2100 and the bodies 120, 120′, and 120″ of the inserts 100, 100′, and 100″. In example embodiments, the spacers 180, 180′, and 180″ may be, but are not limited to, ring type structures or protrusions that may protrude from the outside surfaces of the bodies 120, 120′, and 120″. The spacers 180, 180′, and 180″ may be attached to or directly attached to the bodies 120, 120′, and 120.″

Thus far, example embodiments disclose various assemblies 1000, 1000′, and 1000″ with inserts 100, 100′, and 100″ having insert bodies 120, 120′, and 120″ and bearing structures 110, 110′, and 110″ near an end of the insert bodies 120, 120′, and 120″. Each of the assemblies 1000, 1000′, and 1000″ may include an applicator unit 300 in the insert bodies 120, 120′, and 120″, wherein the applicator unit 300 includes a first tube 320, a second tube 330, and a sealing body 310 configured to seal the insert bodies 120, 120′, and 120″. Although example embodiments illustrate the insert bodies 120, 120′, and 120″ as being cylindrical structures, example embodiments are not limited thereto. For example, the insert bodies 120, 120′, and 120″ may resemble any tube shaped structure (for example, square tube or rectangular tube or a tube having a hexagonal or octagonal cross section) and the sealing body 310 may be configured to seal an end of the insert consistent with the above description. In each of the assemblies 1000, 1000′, and 1000″ the first tube 320 and the second tube 330 may be arranged in the insert bodies 120, 120′, and 120″. In example embodiments, the sealing members 200 may surround the insert bodies 120, 120′, and 120″ as shown in the figures. In example embodiments, the sealing members 200 may be o-rings.

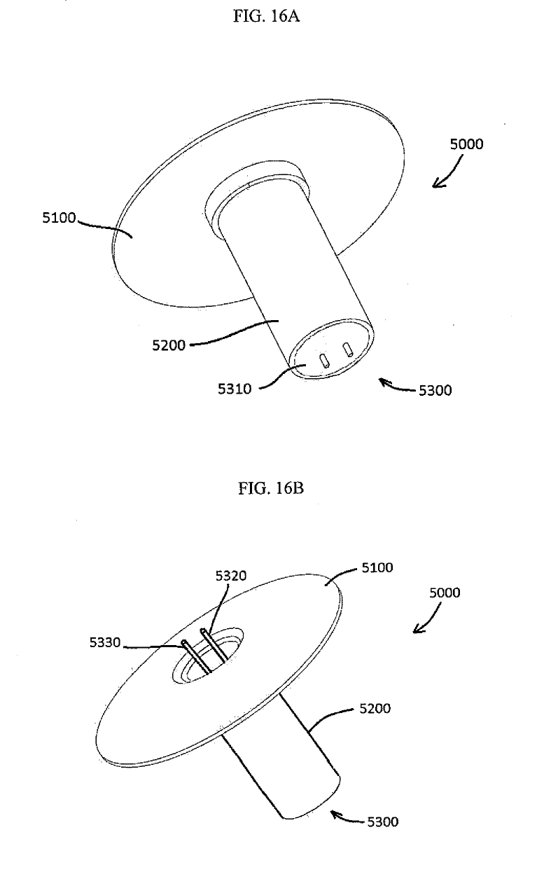

FIGS. 15A and 15B illustrate a modification of the assembly 1000. In FIGS. 15A and 15B, the assembly 1000M1 is substantially identical to the assembly 1000 except that the assembly 1000M1 does not have a sealing member 200 around the cylindrical body 120. Rather, in FIGS. 15A and 15B, a sealing member 200M1 (for example, an O-ring) is attached to the structure 2000. In this latter embodiment, an air tight seal is made when the flange of the assembly 1000M1 presses against the sealing member 200M1 as shown in FIG. 15B. In either case, however, the sealing member 200 and the sealing member 200M1 are sandwiched between the flanges of the assemblies 1000 and 1000M1 and the structure 2000 when the assemblies 1000 and 1000M1 are inserted into the cavities 2100.

Other modifications also fall within the inventive concepts of this application. For example, in the assemblies 1000′ and 1000″ the washers 110′ and 110″ may be omitted and the snap ring 115′ and the nut 115″ may serve as bearing structures upon which the sealing member 200 may bear against. In addition, although example embodiments illustrate the applicator unit 300 as being comprised of a sealing body 310 that may be made of an elastic material such as, but not limited to, rubber or a cork type material, example embodiments are not limited thereto. For example, in example embodiments the sealing body 310 may actually be formed by dipping an end of the cylindrical body 120 in rubber to create, at the second end, the sealing body 310. In the alternative, the sealing body 310 may be expandable foam which is injected into the end of the cylindrical body 120. As yet another example, the sealing body 310 may be a plate welded to an end of the cylindrical body 120 with two holes through which the tubes 320 and 330 may pass. As yet another example, the insert 100 may be formed through a casting process wherein an end of the insert 100 is closed with at least one hole, for example, two holes, through which the tubes 320 and 330 may pass. In this latter embodiment, it is understood that the portion of the insert closing the end may be considered a sealing body 310.

FIG. 6D illustrates a cross section of an alternative assembly 1000* which includes some of the aforementioned alternative features. For example, FIG. 6D illustrates the assembly 1000* as being comprised of a flange 110*, sealing member 200*, first tube 320* and second tube 330* which may be substantially identical to the previously described flange 110, sealing member 200, and first and second tubes 320 and 330. However, unlike the previously described embodiment, the assembly 1000* of example embodiments includes a cylindrical body 120A* having a closed end 120B*. In this latter example, the cylindrical body 120A* and closed end 120B* may be integrally formed as through a casting process. In this nonlimiting example of an assembly 1000*, the closed end 120B* may be provided with at least one aperture, for example, a first and second aperture, through which the first and second tubes 320* and 330* may pass.

FIG. 6E illustrates a cross section of an alternative assembly 1000** which includes some of the aforementioned alternative features. For example, FIG. 6E illustrates the assembly 1000** as being comprised of a flange 110″, sealing member 200**, a first tube 320** and second tube 330** which may be substantially identical to the previously described flange 110, sealing member 200, and first and second tubes 320 and 330. However, unlike the previously described embodiment, the assembly 1000** of example embodiments includes a cylindrical body 120A** having an end closed by a plate 120B** which may be attached to the cylindrical body 120A** by a conventional method such as, but not limited to, gluing or welding. In this latter example, the cylindrical body 120A** and the plate 120B* may be separately formed and then joined together. In this nonlimiting example of an assembly 1000″, the plate 120B* may be provided with at least one aperture, for example, a first and a second aperture, through which the first and second tubes 320** and 330** may pass.

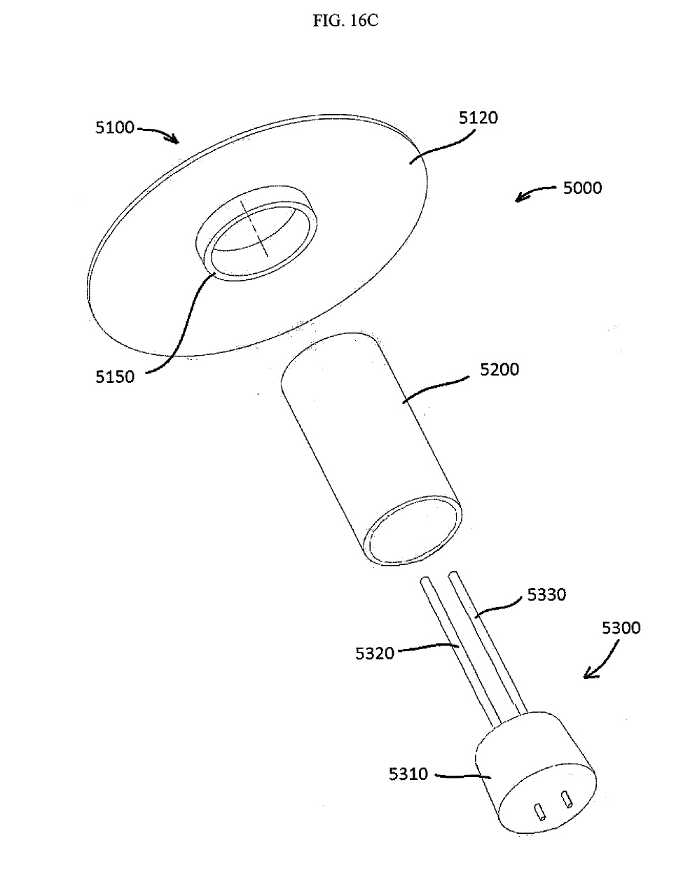

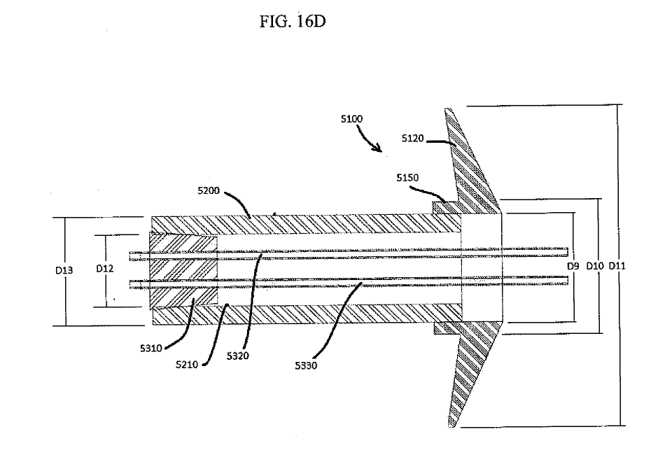

FIGS. 16A-16D illustrate another nonlimiting example of an assembly 5000. In particular, FIG. 16A represents a first perspective view of the assembly 5000, FIG. 16B illustrates a second perspective view of the assembly 5000, FIG. 16C illustrates an exploded view of the example assembly 5000, and FIG. 16D illustrates a cross section view of the assembly 5000.

Referring to FIGS. 16A-16D, the assembly 5000 may include a sealing member 5100, an insert 5200, and an applicator unit 5300. In example embodiments, the applicator unit 5300 may be substantially identical to the earlier described applicator unit 300. For example, the applicator unit 5300 may include a body 5310, a first tube 5320, and a second tube 5330 which may be substantially identical to the body 310, the first tube 320, and the second tube 330 of the applicator unit 300. Because the applicator unit 5300 may be substantially identical to the applicator unit 300, a detailed description thereof is omitted for the sake of brevity.

In example embodiments, the insert 5200 may resemble a hollow tube, for example, a hollow cylindrical tube and may resemble an insert body. For example, the insert 5200 may resemble a hollow cylinder having an annular cross section. The annular cross section may have an inner diameter D12 and an outer diameter D13. In example embodiments, the inner diameter D12 of the insert 5100 may be large enough to allow a portion of the body 5310 of the applicator unit 5300 to fit therein so that a body 5310 may have a snug fit within the insert 5200 as is consistent with the earlier described example embodiments. The body 5310, for example, may create an air tight seal at an end of the insert 5200.

Though not shown in the figures, an inner surface 5210 of the insert 5200 may be fully threaded or partially threaded. For example, the inner surface 5210 may include threads similar to the threads 122 of the insert 100 or threads 122M of the insert 100M. In example embodiments, the inner surface 5210 may be partially threaded or fully threaded depending on how the insert 5200 is intended to be used.

In example embodiments, the sealing member 5100 may include a flange 5120 and a foot 5150. In example embodiments, the flange 5120 and the foot 5150 may be made of a relatively flexible material, for example, rubber. In example embodiments the foot 5150 may resemble a cylinder having an inner diameter D9 and an outer diameter D10. In example embodiments, the inner diameter D9 may be about the same size as the outer diameter D13 of the insert 5200. In example embodiments, the inner diameter of the foot 5150, however, may, in an unattached state, be smaller than the outer diameter D13 of the insert 5200. However, because the foot 5150 may be made of a resilient material, for example, rubber, the foot 5150 may be deformed to accommodate the insert 5200 therein as is shown in the figures. This may cause a snug tight fit between the foot 5150 and the insert 5200.

In example embodiments, the flange 5120 may extend from the foot 5150. The flange 5120 may resemble a tapered disk having an outer diameter of D11. As will be explained shortly, ends of the flange 5120 may contact a structure to position the insert 5200 within a cavity of the structure.

In example embodiments, the sealing member 5100 may be formed as one integral structure, for example, through a casting or machining process. On the other hand, the foot 5150 and the flange 5120 may be formed separately and then joined together through a joining process, for example, using an adhesive or welding, or another means such as pinning or bolting.

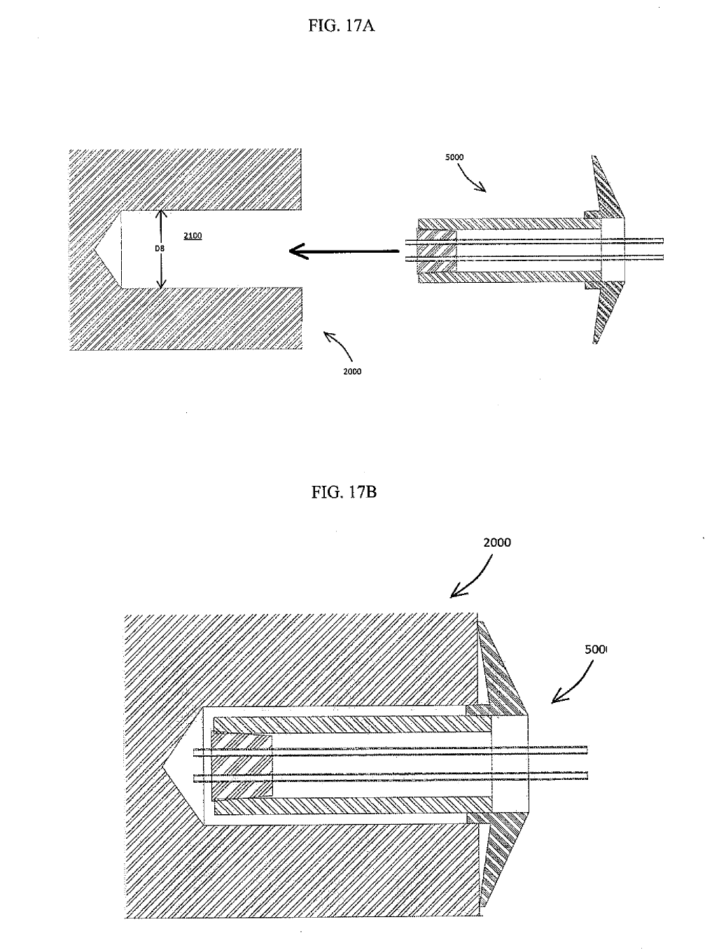

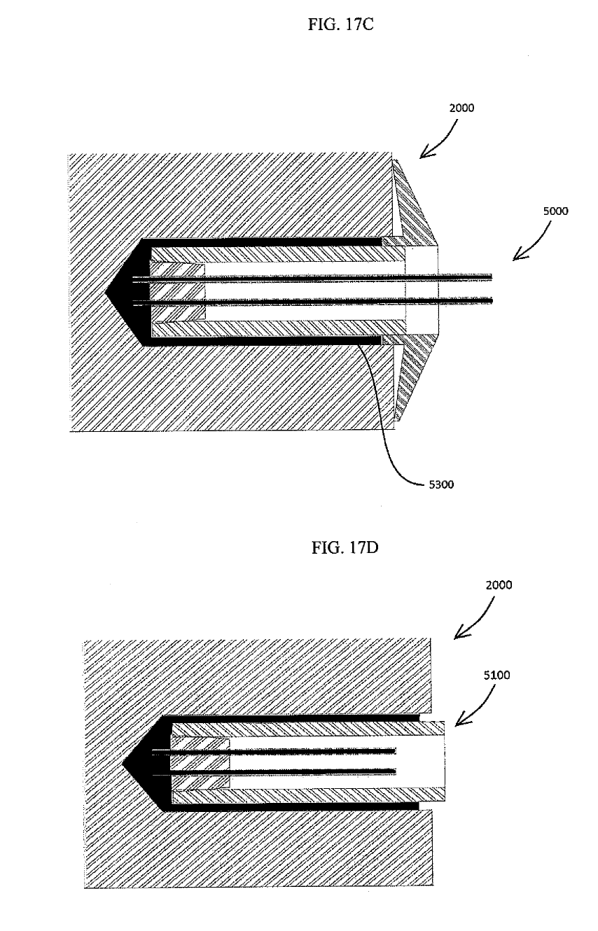

FIGS. 17A-17D illustrate various operations for inserting the assembly 5000 into a cavity 2100 formed in a structure 2000. In example embodiments, the structure 2000 may be, but is not limited to, a wind turbine blade or any other structure having a cavity 2100 therein. Consistent with the earlier examples, the cavity 2100 may be formed in the structure 2000 via a conventional means, for example, boring or drilling, however the invention is not limited thereto. For example, the structure 2000 may be produced via a casting process and the cavity 2100 may be formed during the casting process. In the alternative, the cavity 2100 may be formed using a punching process.

Referring to FIG. 17A, the cavity 2100 may be formed as a cylindrical cavity having a diameter D8. In order to fit within the cavity 2100, the outer diameter D13 of insert 5200 may be smaller than the diameter D8 of the cavity. Also, in example embodiments, the outer diameter D10 of the foot 5150 may be about the same size as the diameter D8 of the cavity 2100. Thus, the foot 5150 may not only position the insert 5200 within the cavity 2100, but may also act as a seal. In example embodiments, the outer diameter D10 of the foot 5150 may be slightly larger than the diameter of the cavity D8. However, since the foot 5150 may be made of a resilient material, the foot 5150 may be deformed to reduce its outer diameter to ensure a snug fit between the structure 2000 and the foot 5150.

Referring to FIG. 17B, the insert 5200 of the assembly 5000 may be inserted into the cavity 2100 until ends of the flange 5120 contact the structure 2000. In this configuration (and consistent with earlier described examples), the space between the insert 5200 and the structure 2000 may be subject to a vacuum through one of the first tube 5320 and second tube 5330. Under the vacuumed state, an adhesive 5300 may fill spaces between the insert 5200 and the structure 2000 by providing the adhesive through the other of the first tube 5320 and the second tube 5330. Because the adhesive is provided under a vacuum, macroscopic voids in the adhesive may be eliminated. After the adhesive is cured, the sealing member 5100 may be removed producing the structure illustrated in FIG. 17D.

Certain features of example embodiments are not intended to limit the invention. For example, while the bodies 120, 120M, 120′, 120″, and 5200 are described and illustrated as cylinders, the bodies 120, 120M, 120′, 120″, and 5200 may have another shape such as, but not limited to, square or rectangular tubes or tubes having an elliptical cross-section, a hexagonal cross section, or an octagonal cross-section. Similarly, the cavity 2100 in the structure 2000 described above are not required to be cylindrical holes formed in a structure. For example, the cavity 2100 may have a square, rectangular, elliptical, hexagonal, or octagonal profile. In addition, the inserts need not be hollow. For example, the inserts may be substantially solid members with channels running therethrough to provide vacuum and adhesive as described above.

Example embodiments of the invention have been described in an illustrative manner. It is to be understood that the terminology that has been used is intended to be in the nature of words of description rather than of limitation. Many modifications and variations of example embodiments are possible in light of the above teachings. Therefore, within the scope of the appended claims, the present invention may be practiced otherwise than as specifically described.

What we claim is:

1. A method of securing an insert to a structure having a cavity, the method comprising:
inserting an insert into the cavity, the insert including a body through which a suction tube and an adhesive delivery tube pass;
creating a vacuum in the cavity by drawing air out of the cavity through the suction tube; and
delivering adhesive into the cavity via the adhesive delivery tube while the hole is under a vacuum.

2. The method of claim 1, wherein the structure is a root of a wind turbine blade.

3. The method of claim 1, wherein the adhesive includes at least one of an epoxy, a polyester, a vinyl ester, a thermoplastic, and a thermosetting plastic.

4. The method of claim 1, wherein inserting the insert into the cavity includes sandwiching a sealing member between the structure and a bearing structure associated with the insert.

5. The method of claim 1, wherein inserting the insert into the cavity includes inserting a foot of a sealing member in the cavity.

6. The method of claim 1, wherein the operation of drawing air out of the hole through the suction tube is terminated before the operation of delivering adhesive into the hole.

7. An assembly comprising:
an insert body,
a sealing member near an end of the insert body; and
an applicator unit in the insert body, wherein the applicator unit includes a first tube configured to provide a vacuum and a second tube configured to provide an adhesive.

8. The assembly of claim 7, wherein the applicator unit includes a sealing body configured to seal an end of the insert body and the sealing body includes one of rubber, cork, and expandable foam.

9. The assembly of claim 8, wherein the sealing member surrounds the insert body.

10. The assembly of claim 9, wherein the sealing member is one of an O-ring and a foot.

11. The assembly of claim 7, further comprising:
a bearing structure adjacent the sealing member.

12. The assembly of claim 11, wherein the bearing structure is one of a flange, a washer, and a nut.

13. The assembly of claim 7, wherein the insert body includes a closed end having at least one aperture through which the first and second tubes pass.

14. The assembly of claim 7, further comprising:
a plate configured to seal and end of the insert body, the plate including at least one aperture through which the first and second tubes pass.

15. The assembly of claim 7, wherein an internal surface of the insert body includes threads.

16. The assembly of claim 7, further comprising:
spacers arranged on an outside surface of the insert body.

17. The assembly of claim 7, further comprising:
a nut, wherein the insert body includes a plurality of threads engaged with threads of the nut.

18. The assembly of claim 7, further comprising:
a snap ring, wherein the insert body includes a groove in which the snap ring is inserted.

19. A structure comprised of:
a base structure having a surface surrounding an insert; and
an adhesive filling a space between the surface and the insert, wherein the adhesive does not include macroscopic voids.

20. The structure of claim 19, wherein the insert includes an internally threaded surface.
